(19) United States
(12) Patent Application Publication
(10) Pub. No.: US 2001/0022011 A1
(43) Pub. Date: Sep. 20, 2001

(54) Door hinge with an integrated doorstop for vehicles

(76) Inventor: Audisio Vittorio, Milano (IT)

Correspondence Address: TRASK BRITT, P.O. BOX 2550, SALT LAKE CITY, UT, 84110, US

(21) Appl. No.: 09/747,569

(22) Filed: Dec. 21, 2000

(30) Foreign Application Priority Data
Mar. 7, 2000 (IT) TO2000U000040

(51) Int. Cl. E05D 11/10

(52) U.S. Cl. 16/334

(57) ABSTRACT

A door hinge for vehicles, incorporating:

a first hinge element (12) with a hinge-pin carrier (24),

a hinge pin (26) mounted on the said hinge-pin carrier (24) such that it can rotate and axially fixed to the first hinge element (12),

a second hinge element (14) mounted on the hinge pin in a removable manner,

a check plate (54) fixed to the hinge pin (26) and with a number of retaining positions (64), and

an elastic element (42) formed by a shaped metal rod, mounted on the first hinge element (12) and suitable for engaging the said retaining positions (64) to set up a number of check positions between the first and the second hinge elements (12, 14).

The aforesaid check plate (54) carries a number of idle rollers (62) delineating the aforesaid retaining positions (64) between them.

The present invention relates to a door hinge for vehicle that includes an integrated doorstop device suitable for setting up one or more stable check positions for the door. More precisely, the invention relates to a hinge with the characteristics defined in the introduction of the main claim.

In a known solution that is produced by the applicant, the check device incorporates a check plate with a cam-shaped profile that is fixed to a hinge pin and interacts with the extremity of a metal-rod spring carried on a first hinge element, on which the hinge pin is also mounted and is free to rotate.

The purpose of this invention is that of providing a hinge of the above-specified type for vehicle doors that, compared with the solution already produced by the applicant, allows greater positiveness in the checking action.

According to the invention, this objective is achieved by a hinge according to claim 1.

This invention will now be described in detail with reference to the attached drawings, which are supplied purely as a non limitative example, where:

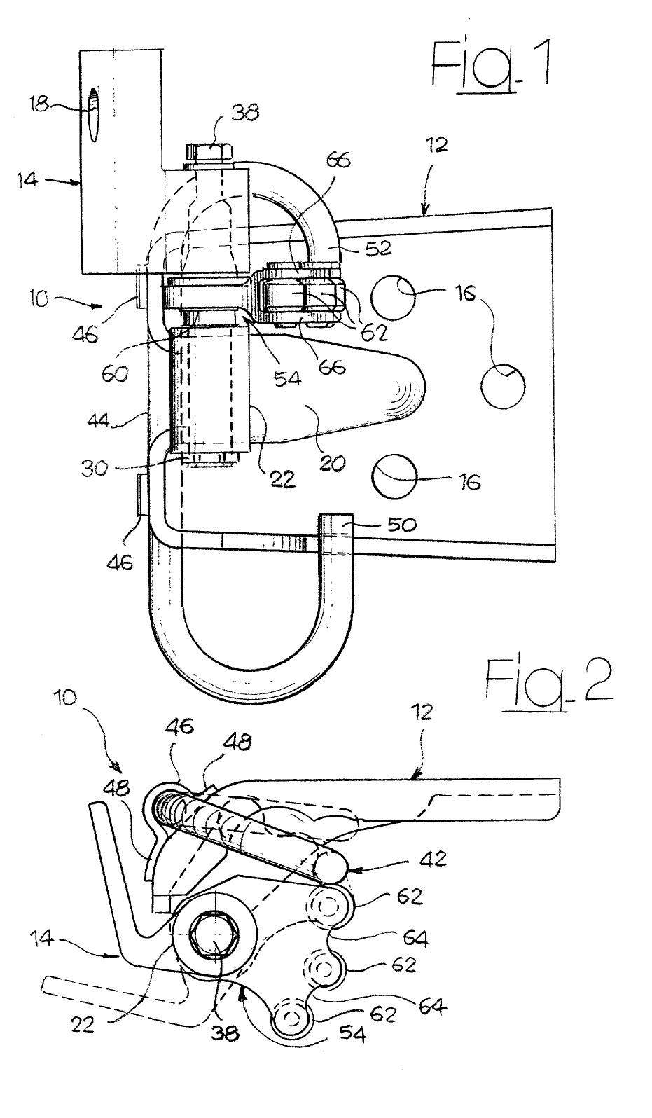

FIG. 1 is a side view of the hinge in conformity with the present invention,

FIG. 2 is a plan view of the hinge shown in FIG. 1,

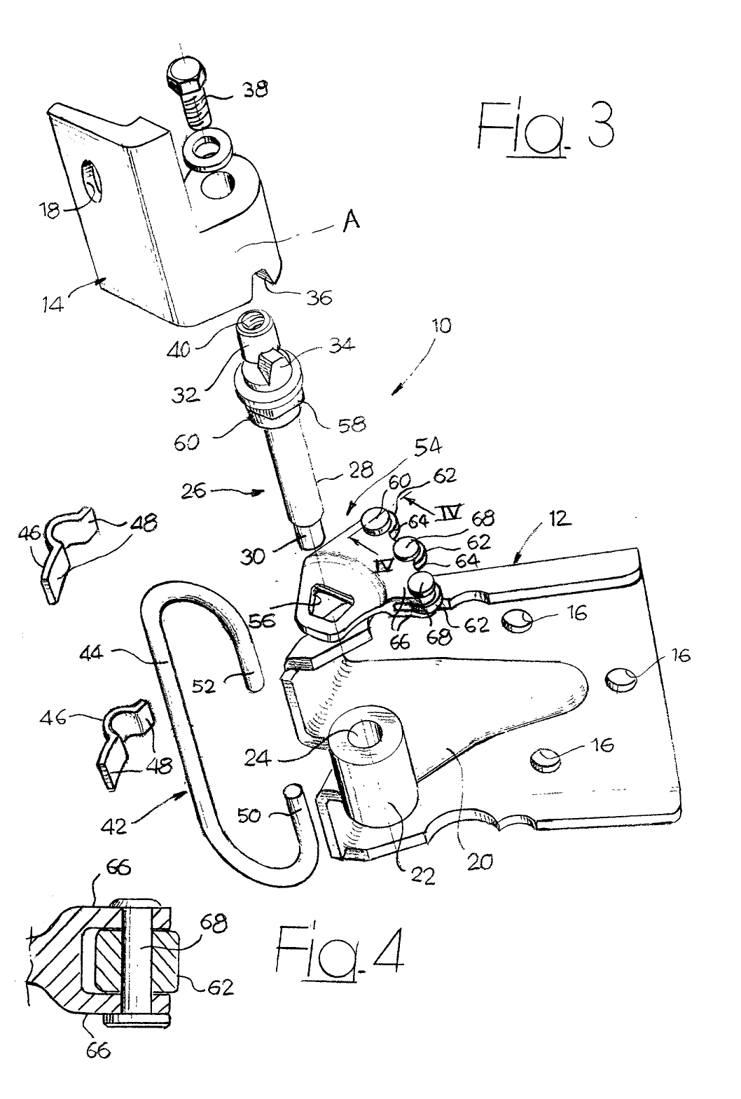

FIG. 3 is an exploded perspective view of the hinge shown in FIG. 1, and

FIG. 4 is a partial section view along the IV-IV line of FIG. 3.

With reference to the drawings, item 10 indicates a door hinge for vehicles including a first hinge element 12 and a second hinge element 14. These hinge elements 12, 14 are both equipped with mounting holes 16, 18 to allow their mounting on the vehicle door pillar and door using bolts (not illustrated). The first hinge element 12 has a rib 20 on which a tubular element 24 is welded to act as the hinge-pin carrier.

The hinge pin 26 has a cylindrical shank 28 that engages in the hinge-pin carrier 24 such that the former can rotate. After inserting the cylindrical shank 28 in the hinge-pin carrier 24, one end 30 of the hinge pin 26 is riveted so that the hinge pin (26) is axially fixed to the first hinge element 12. The other extremity 32 of the hinge pin 26 has a pair of diametrically opposed trapezoidal teeth 34 that engage with the respective apertures 36 present on the second hinge element 14. The second hinge element 14 is fixed to the hinge pin 26 in a removable manner using an axial bolt 38 that engages with the threaded hole 40 of the hinge pin 26.

The first hinge element 12 carries an elastic element 42 consisting of a C-shaped metal rod. The central part of the elastic element 42 is constrained against the first hinge element 12 by a pair of ?-shaped metal brackets 46, the ends on which are welded to the first hinge element 12. The elastic element 42 has one end 50 that rests against the first hinge element 12 and the other end 52 that interacts with a check plate 54.

The check plate 54 is preferable made of sintered steel and has a polygonal-shaped hole 56 that mates with a similarly shaped portion 58 of the hinge pin 26. The check plate 54 is permanently fixed to the hinge pin 26 via upsetting part 60 of the hinge pin 26 after inserting portion 58 in the hole 56. The check plate 54 carries a number of idle rollers 62, the axes of rotation of which are parallel to the axis of rotation of the hinge pin 26. The gaps between the rollers 62 delineate the check positions that one end 52 of the elastic element 42 is destined to engage with. In the example illustrated in the figure, three rollers 62 are present that define two check positions 64 between them, corresponding, for example, to the partially and fully open door positions. The rollers 62 could be coated with a layer of self-lubricating plastic material.

Preferably, the external part of check plate 54 has a fork-shaped section (FIG. 4) with two parallel walls 66 between which the rollers 62 are inserted. The rollers 62 are mounted to freely rotate on their respective pivot pins 68, which are fixed to the check plate 54 by upsetting one of their ends.

When the first and second hinge elements 12, 14 rotate with respect to each other around the hinge axis A, a relative movement between the check plate 54 and end 52 of the elastic element 42 is generated. When end 52 engages a check position 64, the force generated by the elastic element 42 holds the first and second hinge elements 12, 14 in a relatively stable position, corresponding to a stable check position for the vehicle's door. To move the vehicle's door out of the aforesaid stable check position it is necessary to apply a predetermined force in the opening or closing direction of the door.

The rollers 62 provide a more positive release and check action when the door is in the check positions, and reduce the noise produced by the hinge when it operates. In addition, the hinge conforming to this invention is compact, accurate and low-cost.

1. A door hinge for vehicles, comprising:
a first hinge element with a hinge-pin carrier,
a hinge pin mounted on the said hinge-pin carrier such that it can rotate and axially fixed to the first hinge element,
a second hinge element mounted on the hinge pin in a removable manner,
a check plate fixed to the hinge pin and with a number of retaining positions, and
an elastic element formed by a shaped metal rod, mounted on the first hinge element and suitable for engaging the said retaining positions to set up a number of check positions between the first and the second hinge elements,
wherein said check plate carries a number of idle rollers delineating the aforesaid retaining positions between them.

2. A hinge according to claim 1, wherein said check plate has a fork-shaped portion carrying the said rollers.

3. A hinge according to claim 2, wherein said rollers are mounted to freely rotate around their respective pivot pins, which are fixed to the said fork-shaped portion and run parallel to the axis of the hinge pin.

4. A hinge according to claim 1, wherein said check plate is made of sintered steel.

5. A hinge according to claim 1, wherein said elastic element is C-shaped with a straight section that is bound to the first hinge element via a pair of brackets welded to the first hinge element.
